(19) United States
(12) Patent Application Publication
(10) Pub. No.: US 2024/0213795 A1
(43) Pub. Date: Jun. 27, 2024

(54) POWERED WATER BOTTLE

(71) Applicant: Charles Isgar, Scottsdale, AZ (US)

(72) Inventor: Charles Isgar, Scottsdale, AZ (US)

(21) Appl. No.: 18/146,002

(22) Filed: Dec. 23, 2022

(51) Int. Cl. H02J 7/34; A45F 3/18; H01M 10/46; H02J 7/00

(52) U.S. Cl. CPC H02J 7/342; A45F 3/18; H01M 10/46; H02J 7/0013; A45F 2003/003

(57) ABSTRACT

A powered water bottle is provided. The powered water bottle includes a bottle portion and a powered base located below the bottle portion. The powered base includes a power source and an output, wherein the output is configured to couple the powered base to an external device to supply power to the external device. In other embodiments, a powered water bottle sleeve is provided. The powered sleeve includes a water bottle portion and a powered base coupled on a bottom of the water bottle portion. The powered base comprises a power source and an output, wherein the output is configured to couple the powered base to an external device to supply power to the external device.

### BACKGROUND OF THE INVENTION

### Technical Field

This invention relates generally to a water bottle and more particularly to a water bottle with a power supply.

### State of the Art

The use of water bottles has expanded exponentially over the years. Particularly water bottles that are aluminum vacuum sealed water bottles are very popular. Millions of people carry reusable water bottles. Additionally, nearly every person that carries such water bottles also has a mobile phone or other electronic device that requires recharging or power to operate. Conventionally, in order to charge on the go, the person caries some sort of charger or power bank.

Further, individuals now accessorize the water bottles. These accessories include stickers, varying colored lids, boots and sleeves that provide aesthetic desires of the user. None of these conventional accessories are equipped with ability to provide power for internal devices or external devices.

Accordingly, there is a need for a powered water bottle to power external devices or internal devices.

### SUMMARY OF THE INVENTION

An embodiment includes a powered water bottle comprising: a bottle portion; and a powered base located below the bottle portion, wherein the powered base comprises a power source and an output, wherein the output is configured to couple the powered base to an external device to supply power to the external device.

Another embodiment includes a powered water bottle sleeve comprising: a water bottle portion; and a powered base coupled on a bottom of the water bottle portion, wherein the powered base comprises a power source and an output, wherein the output is configured to couple the powered base to an external device to supply power to the external device.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1A is a side view of a powered water bottle according to an embodiment;

FIG. 1B is a side view of a powered water bottle with a cable for charging the power supply of the powered water bottle according to an embodiment;

FIG. 1C is side view of a powered water bottle charging a phone according to an embodiment;

FIG. 1D is a bottom view of a powered water bottle showing an internal rechargeable battery according to an embodiment;

FIG. 1E is a bottom view of a powered water bottle with a charging cable formed as part of a powered base of the water bottle according to an embodiment;

FIGS. 1F-1G are a bottom views of a powered water bottle with a battery compartment for replaceable batteries according to an embodiment;

FIG. 2A is an exploded view of a powered water bottle sleeve separated from a water bottle according to an embodiment;

FIG. 2B is a side view of a powered water bottle sleeve coupled to a water bottle charging a phone according to an embodiment;

FIG. 2C is a side view of a powered water bottle sleeve coupled to a water bottle according to an embodiment with a zipper according to an embodiment;

FIGS. 3A and 3B are perspective views of a powered water bottle sleeve powering a light coupled to a water bottle according to an embodiment;

FIGS. 4A-4E are side views of a powered water bottle sleeve powering the sleeve portion to illuminate in various colors according to an embodiment;

FIG. 5A is a side view of a powered water bottle sleeve powering the sleeve portion having a flexible screen, the powered sleeve coupled to a phone to receive programmed instruction for displaying a user defined element on the sleeve portion according to an embodiment;

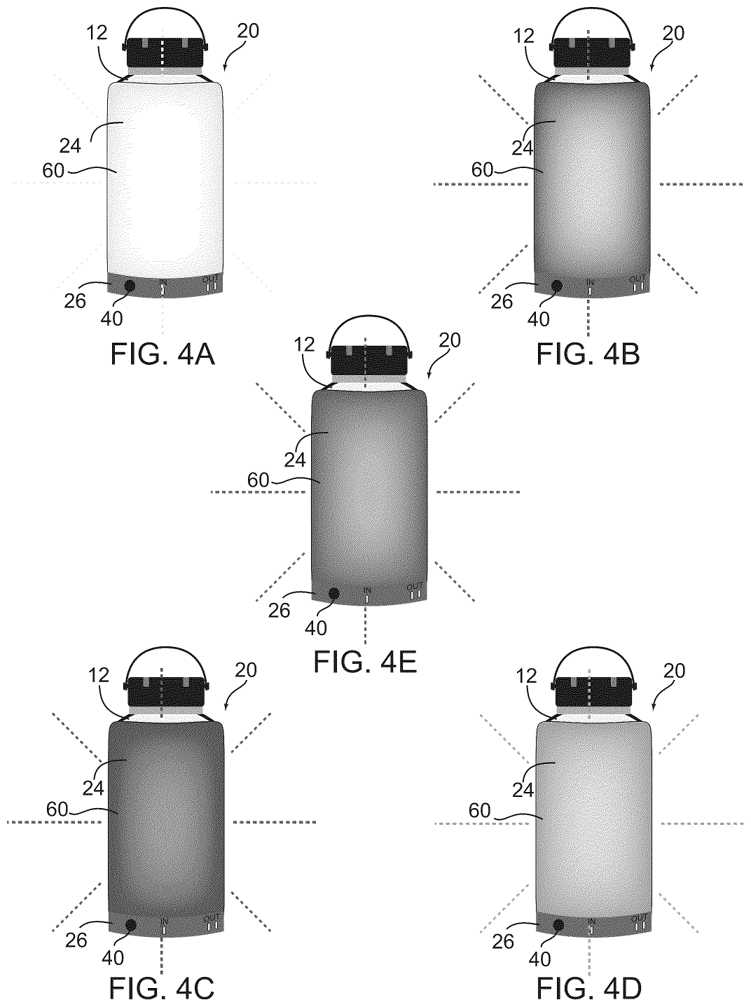

FIG. 4B is a side view of a powered water bottle sleeve powering the sleeve portion having a flexible screen, the powered sleeve coupled to a phone to with the sleeve portion mirroring the phone screen according to an embodiment;

FIG. 6 is a side view of a powered water bottle sleeve powering the sleeve portion to illuminate a graphic on the sleeve portion according to an embodiment;

FIG. 7 is another side view of a powered water bottle sleeve powering the sleeve portion to illuminate a graphic on the sleeve portion according to an embodiment;

FIG. 8A is a view of multiple powered water bottle sleeves carried by people that are more than a predetermined distance apart according to an embodiment;

FIG. 8B is a view of multiple powered water bottle sleeves carried by people that are within a predetermined distance apart according to an embodiment;

FIG. 9 is a view of a powered water bottle sleeve emitting light as a safety feature of a pedestrian on a side of a road according to an embodiment;

FIG. 10 is a view of a powered water bottle sleeve emitting light as a safety feature on a bicycle according to an embodiment;

FIG. 11A is a view of a powered water bottle sleeve operating as a WiFi hotspot according to an embodiment;

FIG. 11B is a view of a powered water bottle sleeve operating as a 5G network node according to an embodiment;

FIG. 12 is a view of a powered water bottle sleeve comprising a speaker connected to and playing sound from the phone through the speaker according to an embodiment; and

FIG. 13 is a view of a disposable powered water bottle sleeve for use as an advertisement device according to an embodiment.

### DETAILED DESCRIPTION OF EMBODIMENTS OF THE INVENTION

As discussed above, embodiments of the present invention relate to a powered water bottle with a power supply formed as part of the water bottle.

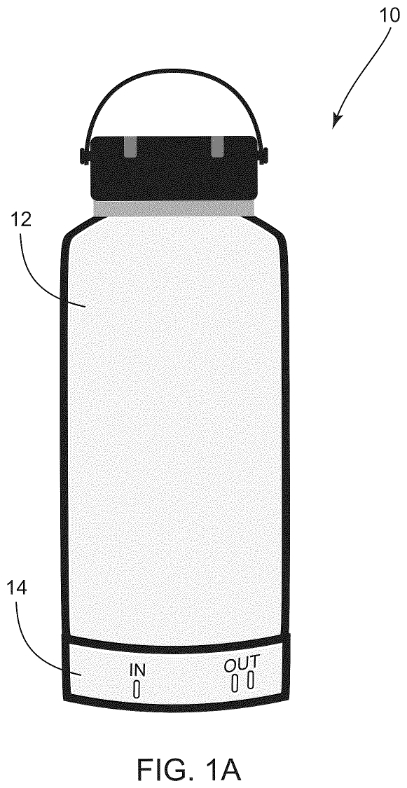

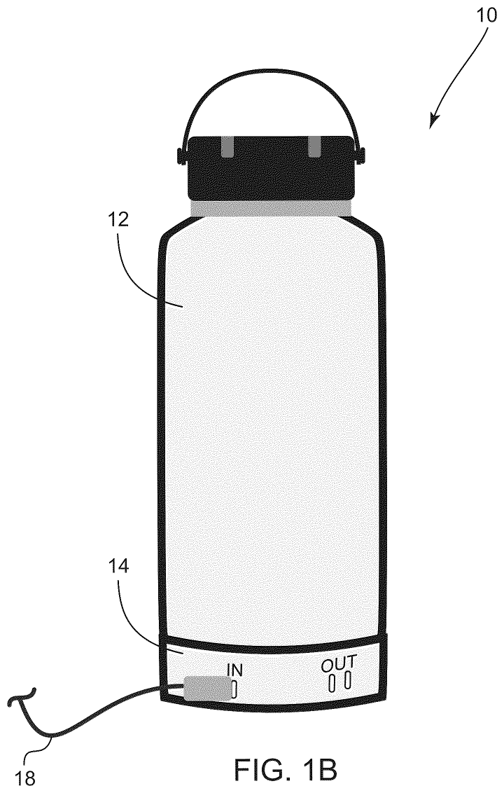

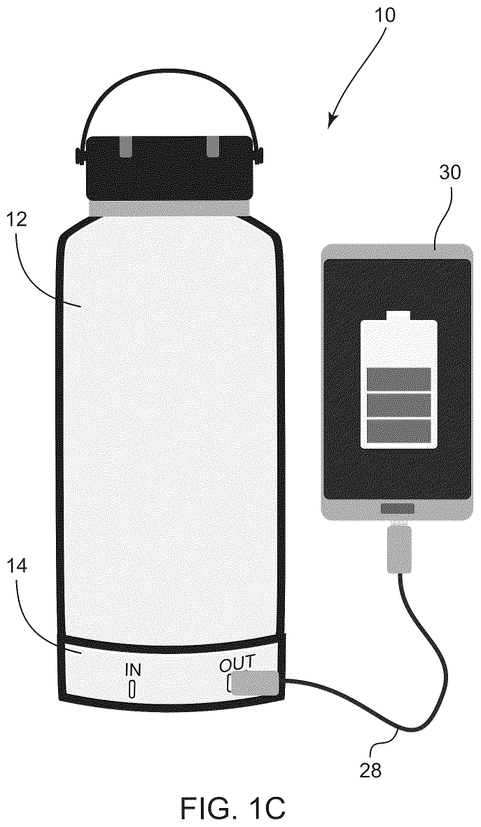

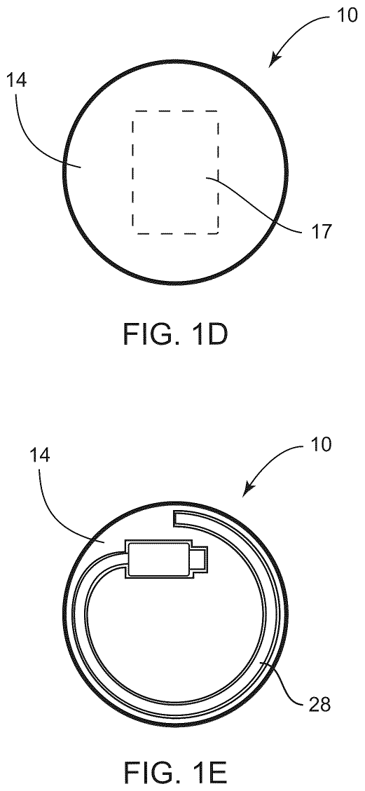

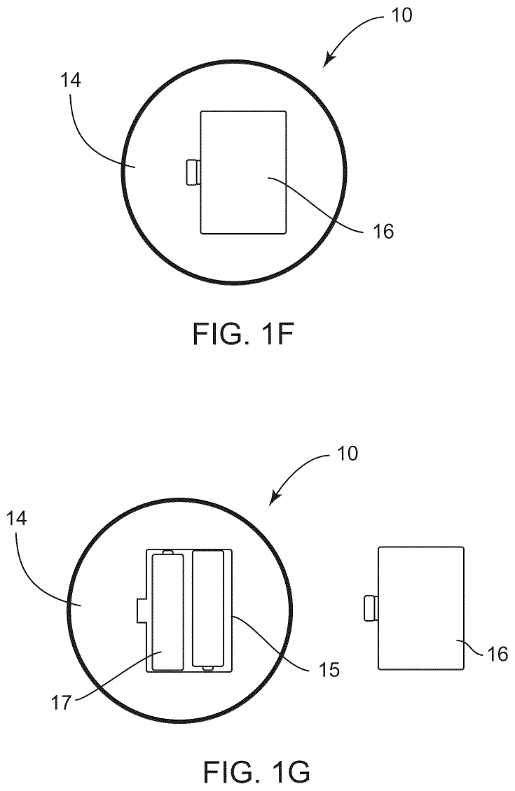

As shown in FIGS. 1A-D, an embodiment of a powered water bottle 10 is depicted. The powered water bottle 10 comprises a bottle portion 12 with a powered base 14. The powered base 14 may comprise an input for coupling to a power source to charge a battery internal to the powered base 14, such as utilizing a cable 18 to couple a power source to the powered base 14 through the input port (see FIG. 1B). The cable 18 directs power to the internal battery 13 (see FIG. 1D) that is rechargeable to store power for use on external devices. For example, once the internal battery 13 is charged, the user may utilize the output elements to connect a cable 28 between the powered base 14 and a phone 30 in order to supply power to the phone 30 to charge the phone utilizing the battery of the powered base 14. While it is shown that the powered base 14 is supplying power to charge a phone 30, any external device that can be plugged into the output to utilize power supplied from the powered base 14 of the powered bottle 10 to operate, charge or the like the phone or other external device.

Some embodiments, as shown in FIGS. 1A-1D operate with an internal battery 13 and utilizes a separate cable 28 to connect to an external device, another embodiment, as shown in FIG. 1E, depicts a cable 28 that is formed as part of the powered base 14 that can be used to connect to a phone 30 or other external device that needs power. Further, in some embodiments the powered base 14 may also have replaceable batteries 17 that operate either as the power source for the powered base 14 or as a supplemental power to the internal battery 13. As shown in FIG. 1G, the replaceable batteries 17 may be housed in a compartment 15 having a removable lid 16. This allows the batteries to be replaced when depleted without the need to charge the internal battery 17 of the powered base 14.

While it is shown and described that the water bottle 10 includes a powered base 14, it will be understood that the powered portion of the water bottle 10 may be located in other places in the bottle portion 12 of the powered water bottle 10. Further, in some embodiments, the powered base 14 may be sealed and water proof or resistant for tasks such as washing the bottle portion 12, use in inclement weather, or the like.

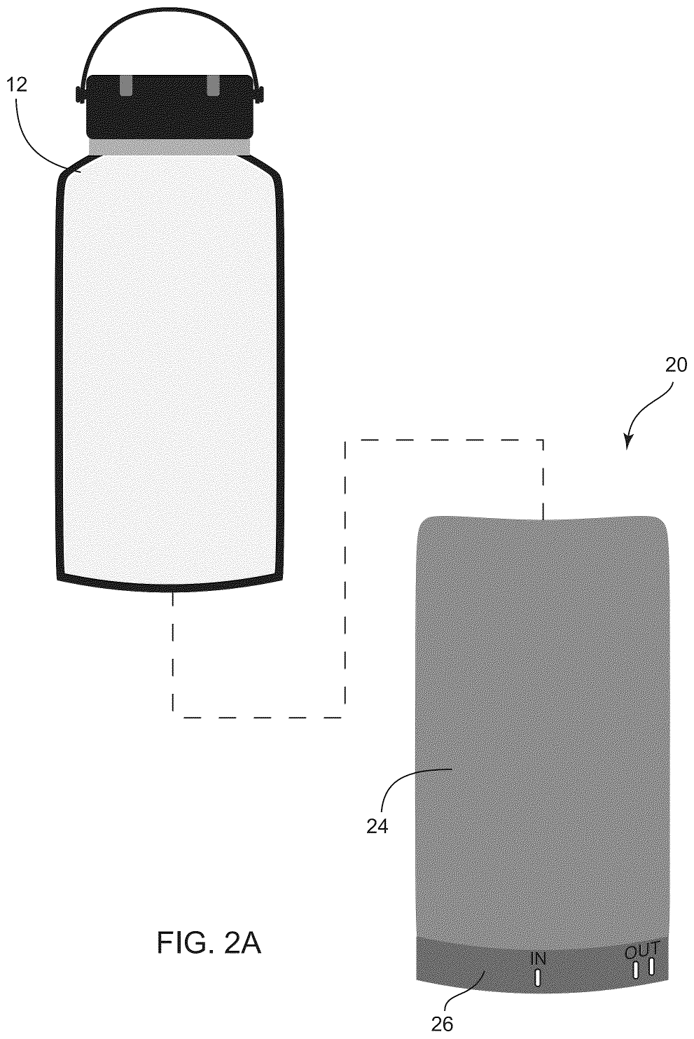

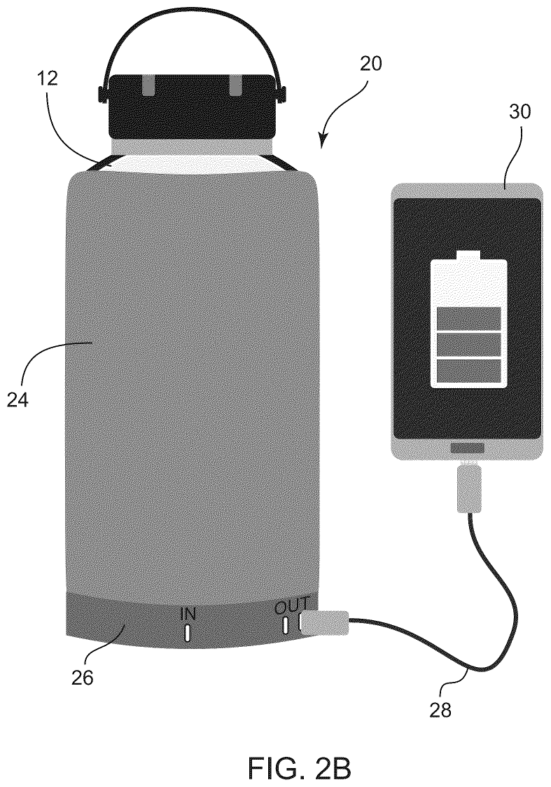

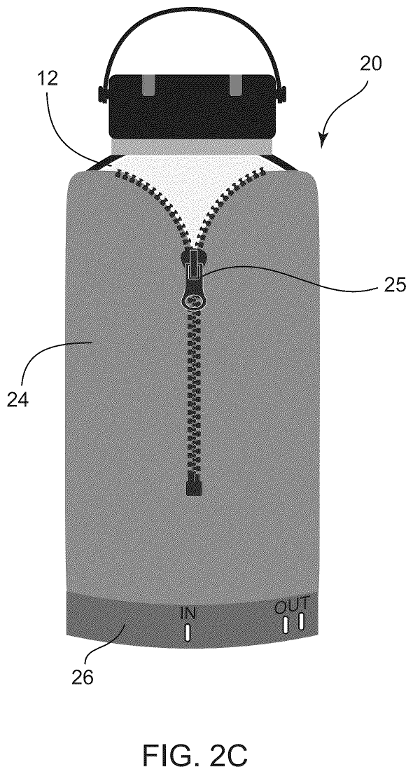

Referring to the drawings, FIGS. 2A-2C depict embodiments of a powered water bottle sleeve 20. The powered sleeve may include a sleeve portion 24 and a powered base 26, wherein the sleeve portion 24 is sized and shaped to couple to a water bottle 22. When coupled to the water bottle 22, the sleeve portion 24 is coupled around the water bottle 22 and the powered base 26 is coupled adjacent the bottom of the water bottle 12 such that the powered base 26 operates as the bottom of the water bottle 12.

As shown in FIG. 2B, the powered sleeve 10 may include a powered base 16 having an input for coupling to a power source to charge a battery internal to the powered base 16. Plugging in the powered base 16 supplies power to the internal battery that is rechargeable to store power for use on external and/or internal devices. As shown in FIG. 2B, the output elements may be used to connect a cable 28 between the powered base 26 and a phone 30 to supply power to the phone 30 to charge the phone utilizing the battery of the powered base 26. While is shown that the powered base 26 is supplying power to charge a phone 30, any external device that can be plugged into the output to utilize power supplied from the powered base 26 of the powered sleeve 24 to operate, charge or the like.

The powered sleeve 20 may be slid over the bottle 12 and remain in place with a friction between the bottle and the bottle portion 24 of the sleeve 20. In other embodiments, as shown in FIG. 2C, the sleeve 20 may be coupled to a bottle 12 with a coupling device 25, such as a zipper, hook-and-loop fastener or the like.

It will be understood that the functionality directed to the powered water bottle 10 or the powered water bottle sleeve 20 are interchangeable. The components described in the water bottle 10 may be incorporated into the sleeve 20 and the components described in the sleeve 20 may be incorporated into the water bottle 10.

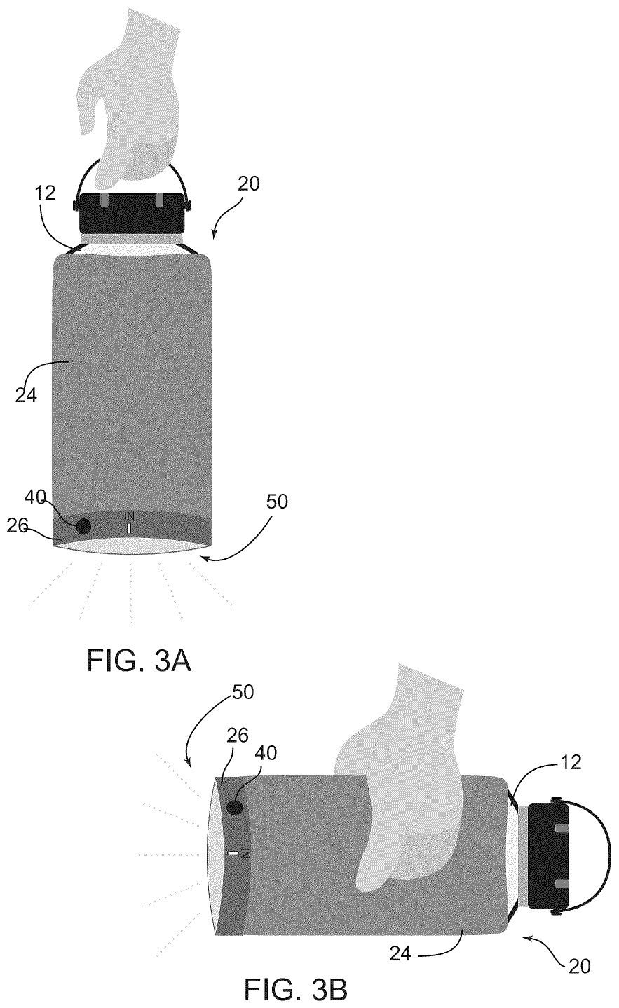

Other embodiments, as depicted in FIGS. 3A-13 depict additional utilization of power supplied to a bottle 12 such as powered bottle 10 or as a powered bottle sleeve 20. For example and without limitation, a light 50 may be located within the powered base 26 that may be turned on and off utilizing a power button 40 as shown in FIGS. 3A-3B. The light 50 can operate as a lantern or a flashlight depending on the direction the water bottle 12 is held.

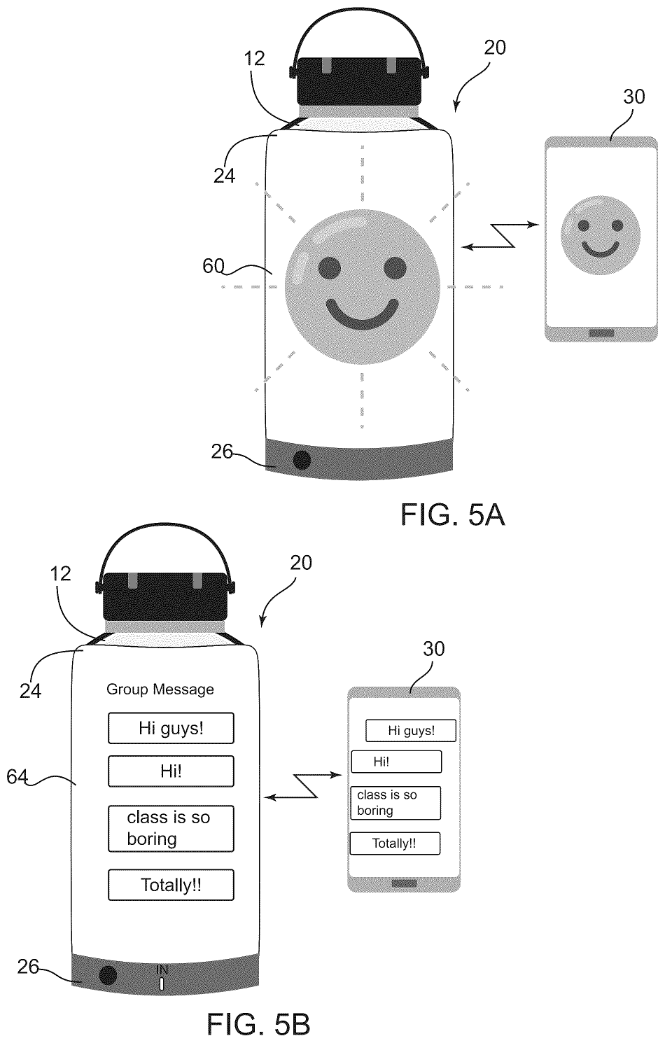

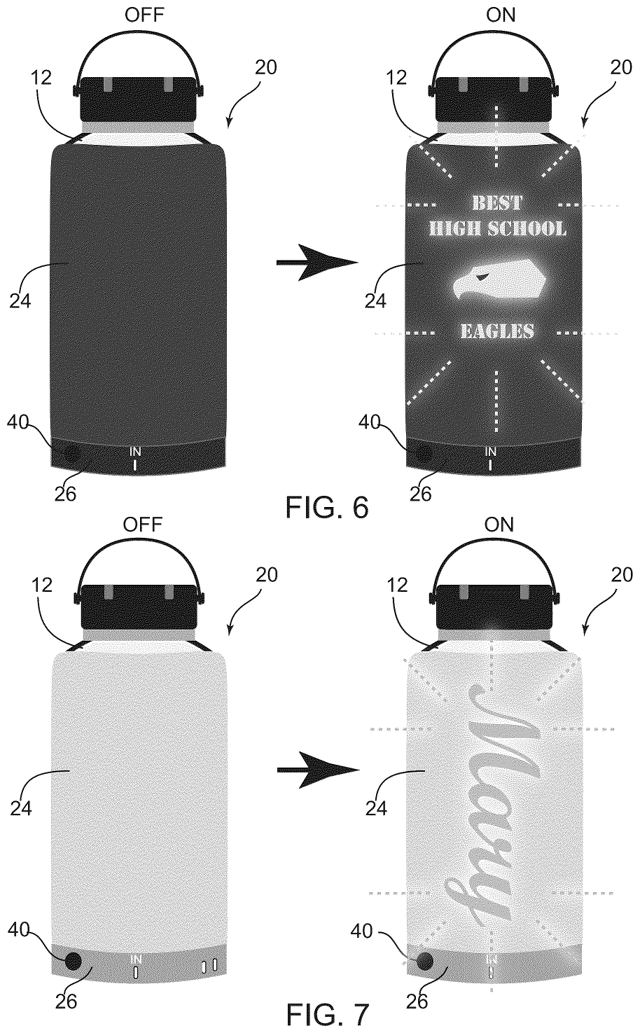

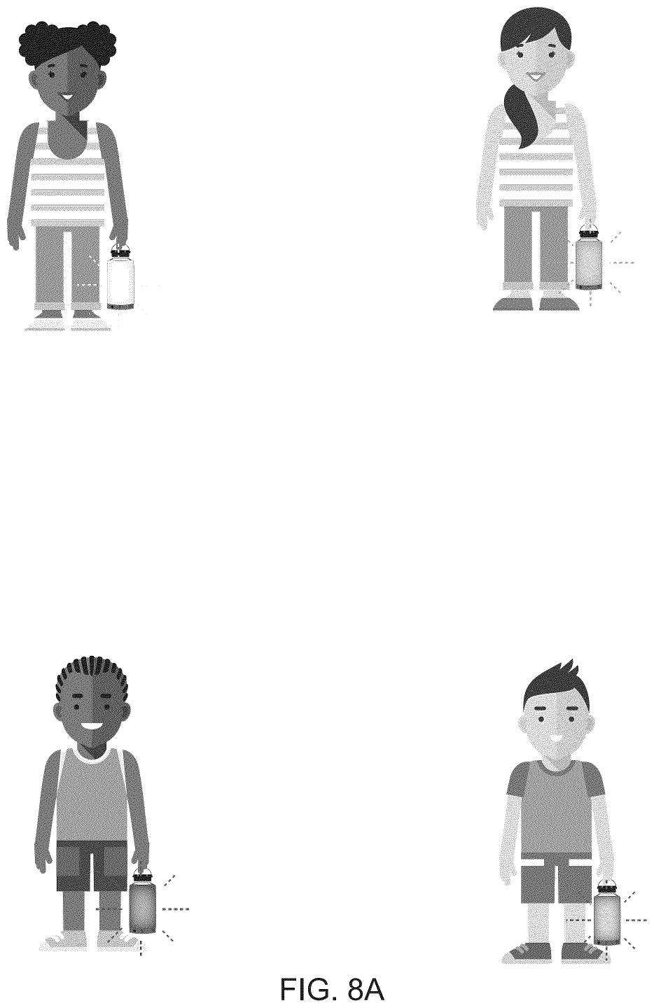

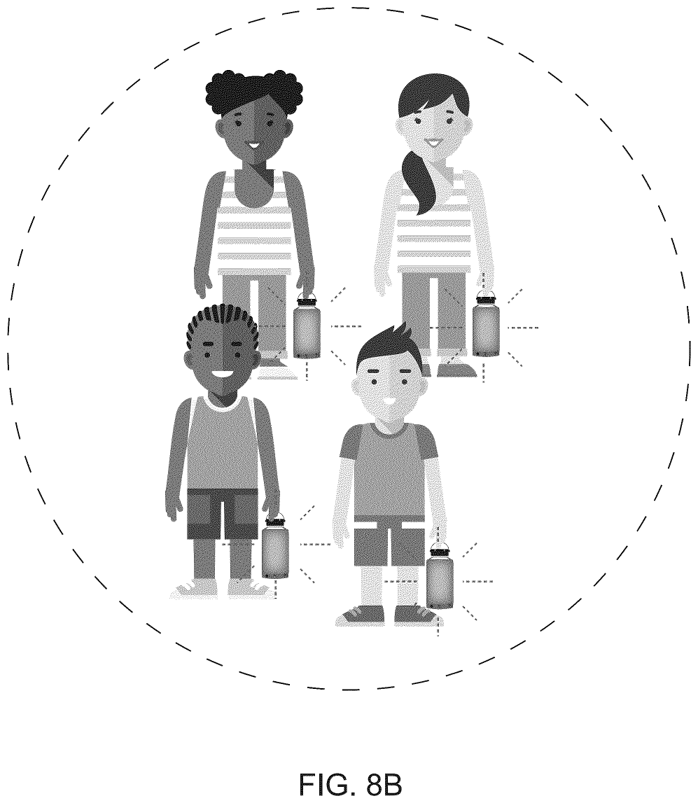

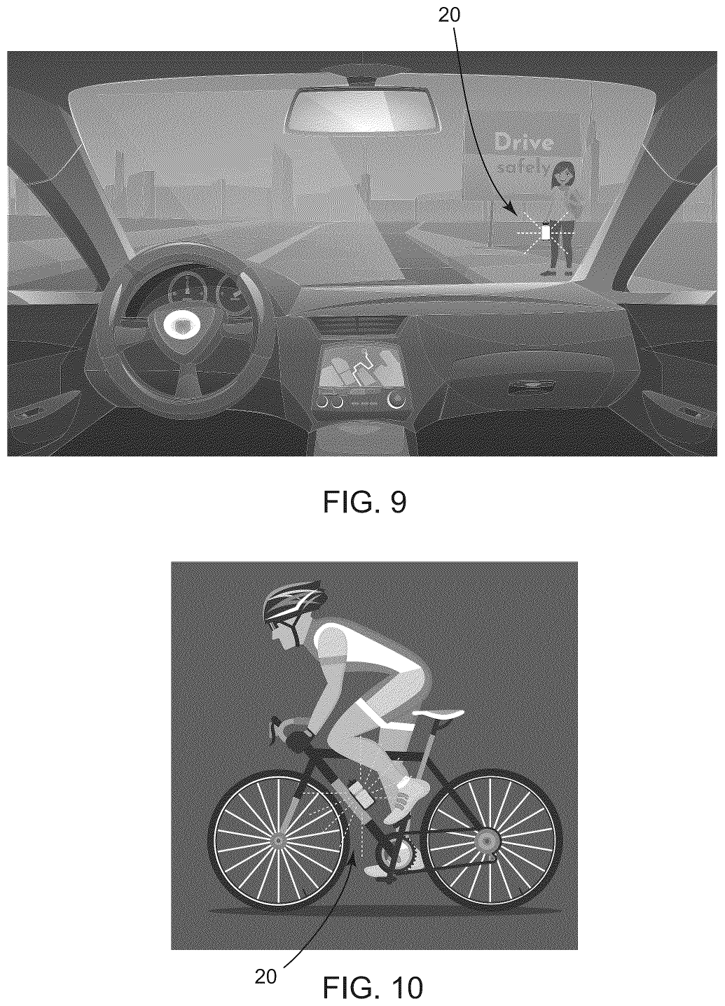

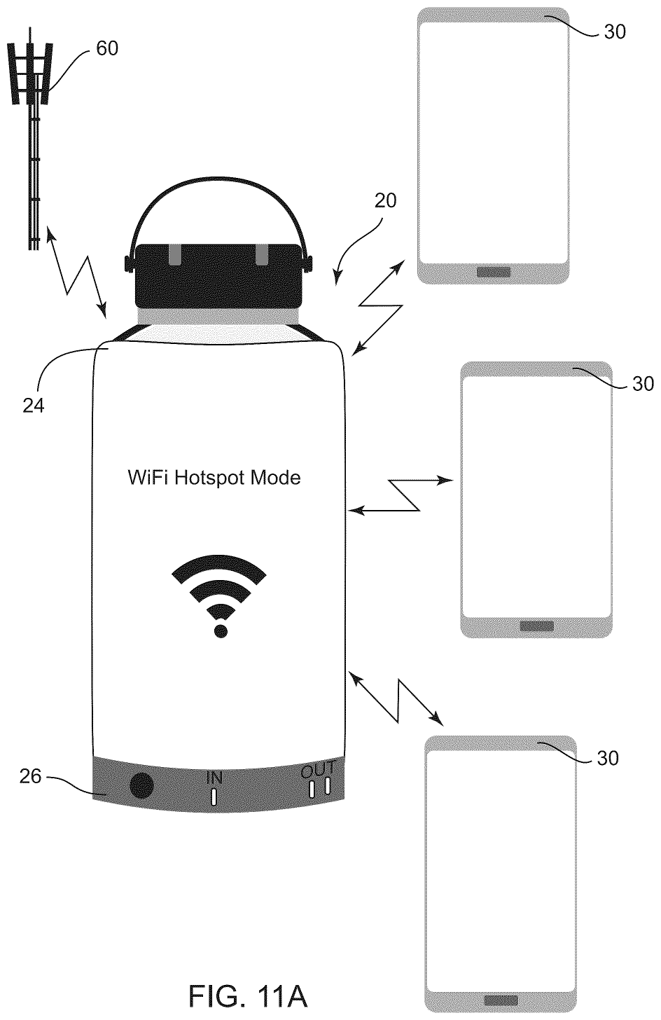

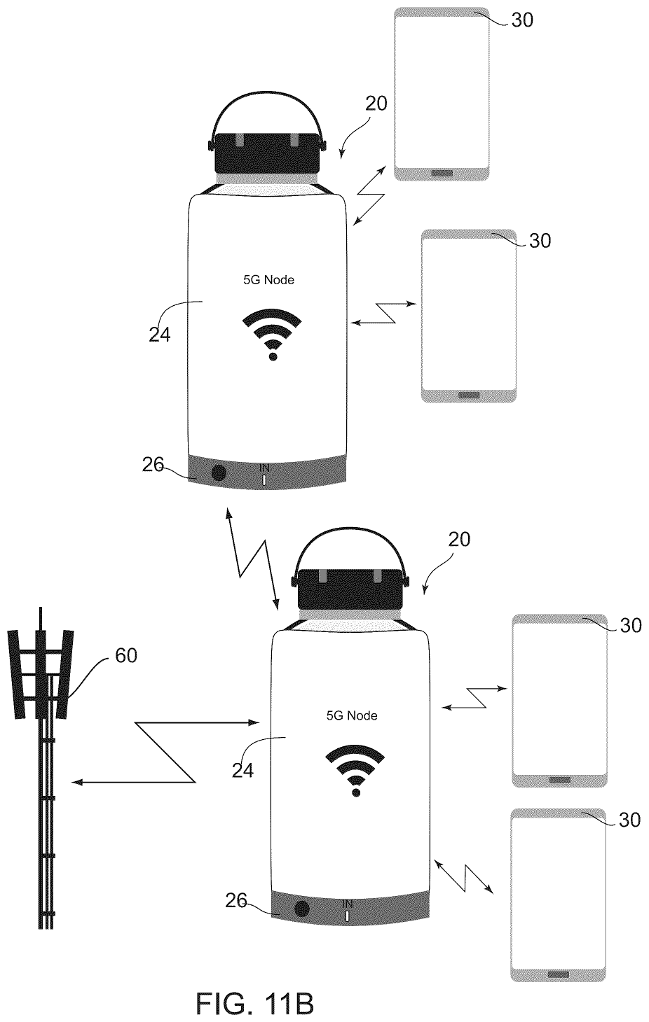

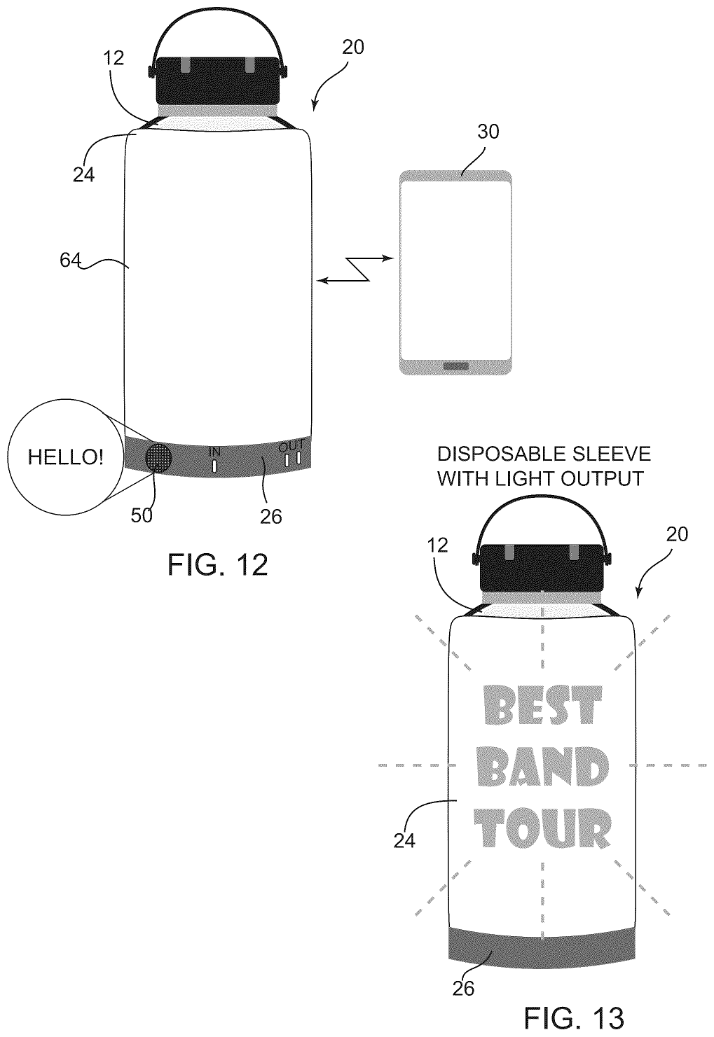

Other embodiments depict a sleeve portion 24 of the powered sleeve 20 that may include an illuminating element 60 that may be turned on and off as depicted in FIGS. 4A-4E. The depressing of power button 40 operates to supply power form the powered base 26 to the illuminating element 60 of the sleeve portion 24. The illuminating element 60 may illuminate various colors, such as yellow (FIG. 4A), red (FIG. 4B), blue (FIG. 4C, green (FIG. 4D), purple (FIG. 4E), and the like. Referring additionally to FIGS. 5A and 5B, the color of the illumination may be controlled by a user computing device 30 such as a phone 30. The phone 30 may be coupled wirelessly, such as through Bluetooth, WiFi or the like and the phone can send a signal to control the color. Additionally, the sleeve portion may have a flexible screen. In these embodiments, the phone 30 may control more than just a color of the sleeve portion 24. For example, the phone 30 may be used to display a graphic such as an emoji on the illuminating elements 60 (see FIG. 5A) or to mirror a screen of the phone 30 (see FIG. 5B).

Other embodiments may include a graphic that lights up like a school mascot (see FIG. 6) or a name (see FIG. 7). It may be utilized as a safety element lighting to show a person walking on a side of the road (see FIG. 9) or on a bicycle (see FIG. 10). Additionally, because these powered bottles 10 or powered sleeves 20 may smart device, either internally or through a connected to a phone 30. This allows them, as shown in FIGS. 8A-8B to illuminate a various color until more than one is within a predetermined proximity or geofence, the illuminating element may change to a same color to indicate that the water bottles 10 are near each other. Further, the powered base may include a speaker 50, see FIG. 12, that can play audio from the phone 30. There may also include a disposable sleeve, as shown in FIG. 13, wherein the powered base 26 is a single use power supply and an illuminating element is provided as an advertisement element or other element that can be used in a temporary manner. After the powered base 26 is depleted in the disposable sleeve it can be disposed of.

In another embodiment, the powered water bottle 10 or the powered water bottle sleeve 20 may operated as a source for wireless connectivity for the phones 30 or other user computing devices. As shown in FIG. 11A, the powered water bottle 10 or the powered water bottle sleeve 20 may operate as a WiFi hotspot, wherein the powered water bottle 10 or the powered water bottle sleeve 20 may be coupled to a cell tower 60 or other WiFi source and then one or more phones 30 may then connect to WiFi hotspot provided by the powered water bottle 10 or the powered water bottle sleeve 20. In a similar manner, as shown in FIG. 11B, the powered water bottle 10 or the powered water bottle sleeve 20 may operate as a 5G node, wherein the powered water bottle 10 or the powered water bottle sleeve 20 may be coupled to a cell tower 60 and one or more powered water bottles 10 or the powered water bottle sleeves 20 may then be coupled to each other and operate as extension of the 5G antenna to create a stronger signal for phones 30 coupled to the 5G node provided by the powered water bottle 10 or the powered water bottle sleeve 20.

Embodiments may be available on or through the internet, such as through domain names reserved and owned by Applicant that include power-bottle.com, chargerbottle.com, fabflask.com, faveflask.com and the like.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A powered water bottle comprising:
a bottle portion; and
a powered base located below the bottle portion, wherein the powered base comprises a power source and an output, wherein the output is configured to couple the powered base to an external device to supply power to the external device.

2. The powered water bottle of claim 1, wherein the power source is an internal rechargeable battery.

3. The powered water bottle of claim 2, further comprising an input for supplying power to the internal rechargeable battery to charge the battery.

4. The powered water bottle of claim 1, wherein the power source is one or more replaceable batteries.

5. The powered water bottle of claim 1, wherein powered base further comprises a cable formed as part of the powered base that is configured to couple to the external device to supply power to the external device.

6. The powered water bottle of claim 1, wherein the external device is a mobile phone that is charged by coupling the mobile phone to the powered base.

7. A powered water bottle sleeve comprising:
a water bottle portion; and
a powered base coupled on a bottom of the water bottle portion, wherein the powered base comprises a power source and an output, wherein the output is configured to couple the powered base to an external device to supply power to the external device.

8. The powered water bottle sleeve of claim 7, wherein the power source is an internal rechargeable battery.

9. The powered water bottle sleeve of claim 8, further comprising an input for supplying power to the internal rechargeable battery to charge the battery.

10. The powered water bottle sleeve of claim 7, wherein the power source is one or more replaceable batteries.

11. The powered water bottle sleeve of claim 7, wherein powered base further comprises a cable formed as part of the powered base that is configured to couple to the external device to supply power to the external device.

12. The powered water bottle sleeve of claim 7, wherein the external device is a mobile phone that is charged by coupling the mobile phone to the powered base.
